(19) United States
(12) Patent Application Publication
(10) Pub. No.: US 2007/0095478 A1
(43) Pub. Date: May 3, 2007

(54) Sticking apparatus

(75) Inventors: Akira Dangami, Tokyo (JP); Kenji Kobayashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 10/581,882

(22) PCT Filed: Oct. 26, 2004
(86) PCT No.: PCT/JP04/15840

§ 371 Date: Jun. 6, 2006

(30) Foreign Application Priority Data
Dec. 10, 2003 (JP) 2003-411194

(51) Int. Cl. B65C 9/40; B65C 9/36; B32B 38/00

(52) U.S. Cl. 156/358; 156/378; 156/538; 156/DIG. 24; 156/DIG. 44; 156/DIG. 36

(57) ABSTRACT

A sticking apparatus 10 includes a label sticking unit 12 for holding a label L, a drive unit 13 that supports and moves the label sticking unit 12 in the direction away from/closer to the adherend C to be stuck with label and a space maintaining device 14 for ensuring the distance D between the label L held by the label sticking unit 12 and the surface C1 to be stuck with label of the adherend C to a preset distance. The space maintaining device 14 is mounted on the label sticking unit 12 so as to be movable with the label sticking unit 12. The space maintaining device 14 has a contact member 46, which changes its position when the same comes into contact with the surface C1 to be stuck with label and a single sensor 47 for detecting the position change of the contact member 46, and when the distance D reaches to a preset distance, detects the position of the contact member 46 to stop moving of the label sticking unit 12.

### TECHNICAL FIELD

The present invention relates to a sticking apparatus, particularly to a sticking apparatus capable of swiftly sticking a label onto a plurality of adherends having different size, enabling to improve accuracy of sticking positions of the label.

### BACKGROUND ART

Conventionally, sticking apparatuses for sticking a label onto a surface to be stuck with a label of an adherend have been widely in use. As such sticking apparatuses, following sticking apparatuses are available; i.e., a sticking apparatus equipped with a so-called air jet type label sticking unit, which, after keeping a predetermined distance between a label held by the label sticking unit and the surface to be stuck with the label of the adherend, blows the label by the air to stick the label thereon; and a sticking apparatus equipped with a press type label sticking unit, which, after holding a label at a position away from the adherend, the label sticking unit is moved a predetermined stroke by a cylinder or the like to press and stick the held label onto the surface to be stuck with the label. In a sticking apparatus, in the case where the surface to be stuck with the label is an upper surface of an adherend and adherends having the identical height are conveyed sequentially, when the label sticking unit is set to a predetermined height position, the labels can be stuck sequentially while keeping the distance therebetween to a constant distance. However, in the case where the adherends having different height are conveyed sequentially, it is necessary to suitably change the height of the label sticking unit corresponding to the adherends to ensure the distance therebetween to a constant distance.

Accordingly, as an apparatus in which the height position of the label sticking unit is adjustable corresponding to the height of the adherend, there is, for example, an apparatus of a type disclosed in the Japanese Laid-Open Patent Application No. 77433/1982 (patent document 1).

The sticking apparatus disclosed in the patent document 1 includes a plurality of sensors to detect the height position of the adherends on a belt conveying the same, having a plurality of light emitting elements and a light receiving elements disposed along the vertical direction, a label sticking unit disposed at the downstream side behind the sensors in the conveying direction of the belt and a control unit for controlling the height position of the label sticking unit based on the data detected by the sensors. According to such arrangement, after detecting the height of the adherend with each sensor, the adherend is conveyed to the label sticking unit via the belt, the label sticking unit is moved in the vertical direction by the control unit, and the label is stuck onto the adherend in a state that the distance has been kept to a preset distance.

Patent document 1: Japanese Laid-Open Patent Application No. 77433/1982

### DISCLOSURE OF THE INVENTION

Problems to be solved by the Invention

However, in the sticking apparatus in accordance with the patent document 1, since the sensors and the label sticking unit are disposed at positions away from each other along the belt, in the process of conveying the adherend from the detecting position with sensors to the sticking position with the label sticking unit, error is easily generated between the height of the adherend detected by the sensors and the height of the adherend at the sticking position of the label. Therefore, the accuracy of the distance between the label held by the label sticking unit and the surface to be stuck with the label is deteriorated. As a result, in the air jet type sticking apparatus, there arises such a disadvantage that the label cannot-be stuck to a correct position. Also, in the press type sticking apparatus, the press force of the label becomes unstable leading to damage on the surface to be stuck with the label or unsatisfactory sticking of the label.

Further, since the adherend is detected by a plurality of sensors including the light emitting elements and the light receiving elements, the height of the adherend is detected for each distance of the sensors vertically adjacent to each other. Therefore, correct height of the adherend cannot be detected. In this case also, there arises such a disadvantage that the accuracy of the distance is deteriorated.

### OBJECT OF THE INVENTION

The present invention has been proposed in view of the above disadvantages. An object of the invention is to provide a sticking apparatus capable of correctly and stably ensuring the distance between the label held by the label sticking unit and the surface to be stuck with the label to a preset distance when sticking label to surface to be stuck with label of a plurality of different size adherends.

Means for Solving the Problem

To achieve the above described object, the present invention adopts such an: arrangement that a sticking apparatus comprises: a label sticking unit arranged so as to hold predetermined labels and to be movable in the direction away from/closer to an adherend; and a space maintaining device for ensuring the distance between the label held by the label sticking unit and a surface to be stuck with label of the adherend to a preset distance, wherein the space maintaining device is mounted on the label sticking unit for detecting the distance, and when the detected distance reaches to the preset distance, stops moving of the label sticking unit.

The present invention also preferably adopts such an arrangement that the space maintaining device includes a contact member that changes position thereof when the same comes into contact with the surface to be stuck with label and a single sensor for detecting a position change of the contact member.

Also, such an arrangement may be adopted that the sensor allows the label-sticking unit to move until the distance between the label and the surface to be stuck-with label reaches to the preset distance, while the sensor detects, when the distance reaches to the preset distance, the position of the contact member and outputs a signal to stop moving of the label sticking unit.

Further, it is preferable to adopt such an arrangement that the contact member includes a roller capable of rolling on the surface side to be stuck with label.

### ADVANTAGE OF THE INVENTION

According to the invention, since the space maintaining device is mounted on the label sticking unit, sticking of the label is carried out while ensuring the distance between the label and the surface to be stuck with label to a preset distance without conveying the adherend after the adherend is detected. Therefore, even when sticking the labels sequentially onto a plurality of different size adherends, error of the distance in the conventional apparatus can be prevented from occurring in the process of conveying the adherend and accordingly, the distance can be ensured with a high accuracy. Owing to this, in the case where the label sticking unit is the air jet type, the label can be correctly stuck at a desired position while stably ensuring the label blowing distance. Also, in the case where the label sticking unit is the press type, the label can be reliably stuck correctly with a constant label press force.

Further, since the single sensor is used for the space maintaining device, the arrangement can be simplified. And in the case that the label sticking unit is stopped from moving when the distance reaches to the preset distance, the distance can be correctly ensured to the preset distance compared to the conventional arrangement.

Furthermore, since the contact member is arranged using a roller, the load imparted to the surface side to be stuck with label of the adherend can be reduced to the minimum.

Here, in this description and claims, the wording “away from” means that the adherend and the label or the label sticking unit are separated away from each other; i.e., the movement direction thereof is opposite to that of approaching each other. The distance between the adherend and the label or label sticking unit is not particularly restricted.

### BRIEF DESCRIPTION OF THE DRAWINGS

FIG. 1 is a front view schematically showing a sticking apparatus in accordance with the embodiment.

FIG. 2 is a left side view of the apparatus in FIG. 1.

FIG. 3 is a perspective view schematically illustrating a space maintaining device arranging the sticking apparatus.

FIG. 4 is an explanatory view showing an intermediate state in label sticking process.

FIG. 5 is an explanatory view showing a state after the labels are stuck on an adherend.

### EXPLANATION OF REFERENCE NUMERALS

10 sticking apparatus
12 label sticking unit
14 space maintaining device
46 contact member
47 sensor
51 roller
C adherend
C1 surface to be stuck with label
L label

### BEST MODE FOR CARRYING OUT THE INVENTION

Hereinafter, embodiments of the invention will be described with reference to drawings.

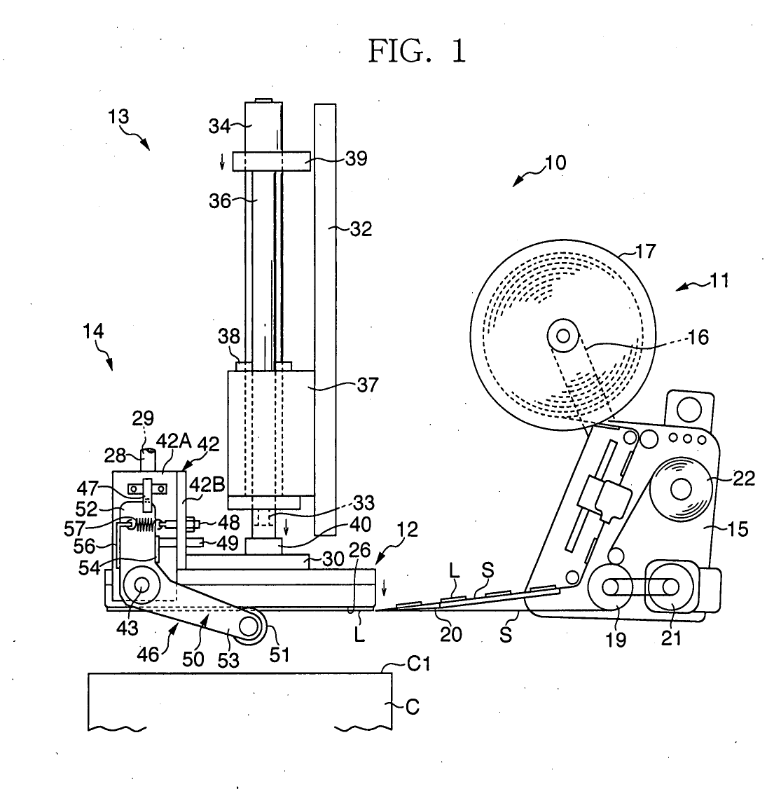

FIG. 1 is a front elevation schematically showing a sticking apparatus in accordance with an embodiment of the present invention. Referring to FIG. 1, a sticking apparatus 10 includes: a label supply unit 11 located at the right side in FIG. 1; a label sticking unit 12 for holding a label L supplied from the label supply unit 11; a drive unit 13 that supports the label sticking unit 12 from an upper portion thereof and drives the label sticking unit 12 to move in the vertical direction; and a space maintaining device 14 provided at the left side of the label sticking unit 12 in FIG. 1.

The label supply unit 11 generally includes: amounting plate 15; a feed-out reel 17, which is rotatably supported by the mounting plate 15 via an arm 16 for feeding out a raw strip sheet in which the labels L are temporarily stuck on one face of a strip of release liner (base sheet) S at predetermined intervals; a feed-out roller 19, which is supported within the face of the mounting plate 15 for imparting a feeding force to the release liner S; a peel plate 20 of which front end is positioned in the vicinity of the label sticking unit 12 and which folds back the release liner S between the feed-out roller 19 and the feed-out reel 17; a motor 21 for driving the feed-out roller 19; and a winding reel 22 for winding the release liner S sequentially from which the labels L have been peeled off.

Note that, in FIG. 1, the label supply unit 11 is shown in a relatively smaller size for the convenience of illustrating, compared to the other arrangements. Therefore, the actual label supply unit 11 is adapted to have a size expanded to such a extent that the label L of the label supply unit 11 is substantially as large as the size of the label L held by the label sticking unit 12.

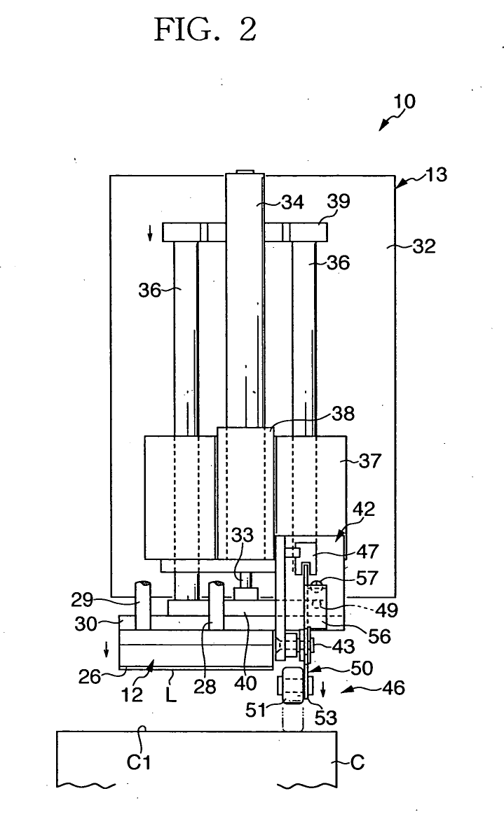

The label sticking unit 12 is a so-called air jet type sticking unit, the lower face of which being set as a suction face 26, is arranged with a suction grid for holding the label L with the suction face 26, and blows the held label L with the air onto an adherend C to be stuck therewith. As shown in FIG. 2, a suction tube 28 located at the right side and an exhaust tube 29 located at the left side are connected to the upper face side of the label sticking unit 12 The suction tube 28 is connected to a suction pump (not shown) and sucks the air through the suction face 26 to hold the label L on the suction face 26. On the other hand, the exhaust tube 29 is connected to an air displacement pump (not shown), and is arranged so as to blow the label L held on the suction face 26 toward the surface C1 (upper surface) of the adherend C to stick the label L thereon. Here, at the upper face side of the label sticking unit 12, a support plate 30 having a size protruding from the right end in FIG. 2 is provided, and the space maintaining device 14 is supported via the support plate 30.

The drive unit 13 is supported via the mounting plate 32 provided above the label sticking unit 12. The drive unit 13 includes: a cylinder 34, which is disposed in the front side of the mounting plate 32 in FIG. 2 (at the left side in FIG. 1) and provided with a rod 33 in a lower end side thereof, the rod moving in the vertical direction; a pair of guide shafts 36, 36 provided at the right and left sides of the cylinder 34 in FIG. 2; a guide shaft leading section 37, which is attached to the mounting plate 32 in a lower area thereof, allowing the guide shafts 36, 36 to go through to be supported; a cylinder supporting section 38, which is provided being nearly embedded in the guide shaft leading section 37, to support the cylinder 34; a first coupling member 39 for coupling between the upper ends of the guide shafts 36, 36; and a second coupling member 40 coupling between the lower ends of the guide shafts 36, 36 and the lower end of the rod 33 being attached to the support plate 30. The drive unit 13 moves the rod 33 of the cylinder 34 forward and backward to drive the label sticking unit 12 in the vertical direction, thereby moves the label L held by the label sticking unit 12 in the direction away from/closer to the surface C1 to be stuck with label of the adherend C. Here, since the guide shafts 36, 36 are coupled with the lower end of the rod 33 via the second coupling member 40, the guide shafts 36, 36 move vertically along with the rod 33, the guide shafts 36, 36 being inserted into the guide shaft leading section 37 so as to stabilize the linear movement of the rod 33.

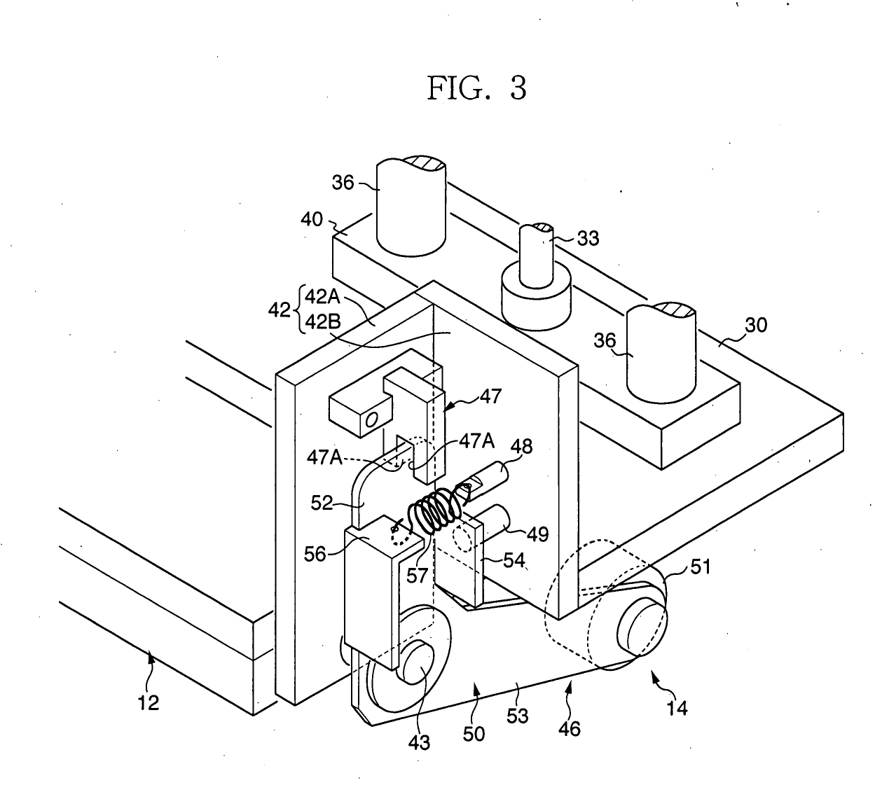

As shown in FIG. 3, the space maintaining device 14 includes: a support member 42 having an L-like shape consisting of a front face portion 42A and a side face portion 42B, which is attached to the label sticking unit 12 via the support plate 30; a support shaft 43 provided in a lower position of the front face portion 42A of the support member 42; a contact member 46 rotatably supported via the support shaft 43 allowing rotary position change; and a single sensor 47 supported in an upper area of the front face portion 42A and located above the contact member 46.

The side face portion 42B of the support member 42 is provided with a first shaft member 48 penetrating a substantially central area of the face thereof and a second shaft member 49 extending substantially in parallel with the first shaft member 48 in an area below the first shaft member 48.

The contact member 46 includes an arm 50 having a substantially L-like shape viewed from the front, and a roller 51, which is supported rotatably by the arm 50 and is positioned in a substantially central area of the label sticking unit 12 in the right and-left direction in FIG. 1.

The arm 50 includes: a vertical piece 52 extending upward from the support shaft 43; an inclined piece 53, which continues to the lower end of the vertical piece 52 and oriented downwardly in the inclined direction and supports the contact member 46 at the lower end side thereof; a protruding piece 54 protruding toward you from the right end side of the vertical piece 52; and a bent piece 56, which continues to the left end side of the vertical piece 52 and is formed in a substantially L-like shape oriented downward viewed from the front. Between the upper end side of the bent piece 56 and the one end portion of the first shaft member 48 (left end portion in FIG. 1), a spring member 57 is provided and the spring member 57 imparts a force to the arm 50 to rotate in the clockwise direction in FIG. 1. On the other hand, the protruding piece 54 abutting on the one end portion of the second shaft member 49 (left end portion in FIG. 1), which functions as a stopper for restricting rotary motion of the arm 50 by the spring member 57 exceeding the position shown in FIG. 1.

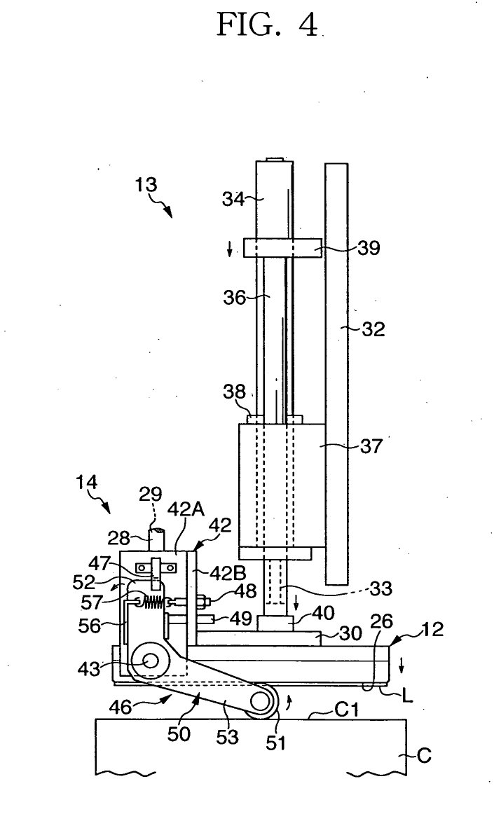

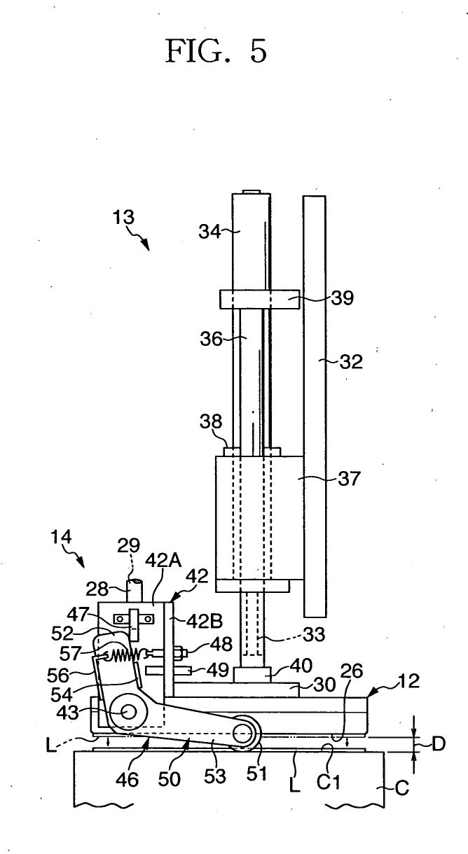

The roller 51 is arranged so as, when the label sticking unit 12 is lowered, to come into contact with the surface side C1 to be stuck with label and rotate causing the arm 50 to provide a rotary position change in the counterclockwise direction as shown in FIG. 4 and FIG. 5.

The sensor 47 includes a light emitting element and a light receiving element (not shown) between opposing faces 47A and 47A of a plate member, which is formed in a concave shape oriented downward, and is adapted so as to detect the upper end of the vertical piece 52 located between the opposing faces 47A and 47A. The sensor 47 is adapted so as, while the label sticking unit 12 is lowered by the cylinder 34, to allow the label sticking unit 12 to be lowered in a state the vertical piece 52 is being detected, and when the vertical piece 52 is out of detection as shown in FIG. 5, to output a signal for stopping the cylinder 34 from moving to stop the label sticking unit 12 from being lowered.

Here, the distance D between the label L when the label sticking unit 12 is stopped from lowering and the surface C1 to be stuck with label is an optimum distance to be preset for blowing and sticking the label L as described above. In other words, the shape, size and mounting position of the arm 50 and the roller 51 forming the contact member 46 are arranged so that, when the distance D reaches the preset distance, the vertical piece 52 goes out from between the opposing faces 47A and 47A.

Note that each pump connected to the suction tube 28 and the exhaust tube 29, the cylinder 34, the sensor 47 and the like are controlled totally through a controller (not shown).

It is arranged so that the adherend C to be stuck with the label is conveyed sequentially below the suction face 26 by a conveying unit such as a conveyer (not shown).

Next, the sticking process of the label L with the sticking apparatus 10 will be described with reference to FIGS. 1, 4 and 5.

Here, it is assumed that a label L supplied from the label supply unit 11 is held by the suction face 26, and an adherend C has been set at a position below the suction face 26 as shown in FIG. 1.

In this state, first of all, the label sticking unit 12 is lowered by the rod 33 of the cylinder 34 to bring the held label L closer to the surface C1 to be stuck with label of the adherend C. At this time, the space maintaining device 14 is also lowered along with the label sticking unit 12. Owing to this descending, the roller 51 is brought into contact with the surface C1 side to be stuck with label and rotates thereon, and the arm 50 rotates in the counterclockwise direction on the support shaft 43 as the rotation center against the force imparted by the spring member 57 as shown FIG. 4. And when label sticking unit 12 is lowered until the distance D between the label L and the surface C1 to be stuck with label reaches the preset distance as shown in FIG. 5, the vertical piece 52 of the arm 50 goes out from the space between the opposing faces 47A, 47A of the sensor 47. The sensor 47 detects the above and outputs a signal for stopping the cylinder 34; thus, the label sticking unit 12 is positioned. In this state, at the same time when suction through the suction tube 28 of the label sticking unit 12 is stopped, the air is exhausted through the exhaust tube 29, and the label L is blown downward from the suction face 26. Thus the label L is stuck onto the surface C1 to be stuck with label.

After sticking the label L, when the label sticking unit 12 is raised via the cylinder 34, the arm 50 rotates clockwise direction by means of the force of the spring member 57. Then, when the protruding piece 54 of the arm 50 comes into contact with the second shaft member 49, the rotation of the arm 50 comes to be restricted. Thus, the arm 50 and the roller 51 return to the initial position and the rod 33 of the cylinder 34 reaches to the return end. Thereafter, when a return signal of the rod 33 is received, a label L is supplied toward the label sticking unit 12 from the label supply unit 11, the next adherend C is conveyed below the suction face 26, and the sticking process of the label L is repeated in the same manner as described above.

Therefore, according to the above-described embodiment, when the sensor 47 detects that the vertical piece 52 of the arm 50 has gone out from the space between the opposing faces 47, 47 of the sensor 47, the label sticking unit 12 is stopped from lowering. Therefore, even when adherends C having different height are conveyed sequentially, the label sticking unit 12 can be positioned at a height in a state the distance D is precisely maintained to the preset distance, and accordingly the label L can be precisely stuck onto the surface C1 to be stuck with label.

The best arrangement and method for carrying out the present invention have been disclosed so far. However, the present invention is not limited to the above.

That is, the present invention has been illustrated and described mainly about a specific embodiment. However, it is possible for ones skilled in the art to add various modifications to the above-described embodiment with respect to the shape, quantity or other detailed arrangement without departing from the technical spirit and the range of the object of the present invention.

Therefore, the above descriptions limiting the configuration and others are given for the purpose of illustrating only to facilitate the understanding of the present invention, but not intended to limit the present invention. Accordingly, the descriptions using different appellations of members removing all or a part of these limitations on the configuration and others should be understood to be included within the present invention.

For example, the label sticking unit 12 may be arranged in such a type that, after the distance D has reached to a preset distance, the rod 33 is further lowered to press the label L held on the suction face 26 onto the surface C1 to be stuck with label. In this case, two air supply sources supplying a different pressure are connected to the cylinder 34 via a solenoid valve. Owing to this, the rod 33 of the cylinder 34 can be lowered relatively swiftly from the state shown in FIG. 1 to the state shown in FIG. 4 by means of the air supply source providing a larger pressure so that the preset distance of the distance D can be obtained swiftly. After that, by changing to the air supply source with a smaller pressure via the solenoid valve to lower the rod 33 at a relatively slow speed, and since the label L is stuck through the movement of the rod 33 of the preset distance, the adherend C can be prevented from being deformed or damaged due to the press force onto the label L.

Also, the design of the drive unit 13 can be variously changed. For example, an arrangement such that the label sticking unit 12 is driven by using a feed shaft or the like employing an appropriate screw structure may be adopted.

Further, the contact member 46 and the sensor 47 are not limited to the illustrated arrangement, but the following arrangement may be adopted. That is, for example, a contact member may be arranged in such a way that the contact member includes a shaft member of which lower end is brought into contact with the surface C1 to be stuck with label and changes its position in the axial direction when the label sticking unit 12 is lowered, and as soon as the distance D has reached the preset distance, a sensor may detect the upper end of the contact member.

Furthermore, the space maintaining device 14 is not limited to the above-described arrangement, but the following arrangement may be adopted. That is, for example, support members extending downward from the suction face 26 may be provided to two different side faces of the label sticking unit 12 respectively, and between the opposing faces of the support members, a light receiving element and a light emitting element of a sensor may be provided. In this case, the mounting position of the light receiving element and the light emitting element in the support members is set to a position preset distance away from the label L held by the label sticking unit 12. Owing to this, when the label sticking unit 12 is lowered, and when the sensor detects the surface C1 to be stuck with label of the adherend C, the lowering is stopped; thereby the distance D is maintained to the preset distance. Still further, as another arrangement of the space maintaining device 14, the following arrangement may be adopted. That is, a so-called reflection type sensor emits a predetermined light beam toward the surface C1 side to be stuck with label, and a sensor for detecting the reflected light beam from the surface C1 to be stuck with label when the distance D has reached the preset distance may be attached to the label sticking unit 12. Owing to the above-described arrangements, the contact member 46 in the space maintaining device 14 can be eliminated.

Still furthermore, the surface C1 to be stuck with label of the adherend C may be the side surface or the like of the adherend C. In this case, the direction of the sticking apparatus 10 has to be changed with respect to the conveyed adherend C.

Further, the label supply unit 11 may be a printer, a barcode printer or the like for printing individual information of the adherend C.

### INDUSTRIAL APPLICABILITY

The present invention is applicable to a sticking apparatus for sticking a label to the surface to be stuck with label of a plurality of adherends conveyed sequentially.

1. A sticking apparatus, comprising:
a label sticking unit arranged so as to hold a predetermined label and to be movable in the direction away from/closer to an adherend; and
a space maintaining device for ensuring a distance between the label held by the label sticking unit and a surface to be stuck with label of the adherend to a preset distance,
wherein said space maintaining device is mounted on the label sticking unit for detecting the distance, and when said detected distance reaches to said preset distance, stops moving of the label sticking unit.

2. The sticking apparatus according to claim 1, wherein said space maintaining device includes a contact member that changes position thereof when the same comes into contact with said surface side to be stuck with label and a single sensor for detecting a position change of the contact member.

3. The sticking apparatus according to claim 2, wherein said sensor allows the label sticking unit to move until a distance between said label and the surface to be stuck with label reaches to a preset distance, and when said distance reaches to the preset distance, detects a position of the contact member and outputs a signal to stop moving of the label sticking unit.

4. The sticking apparatus according to claim 2 or 3, wherein said contact member includes a roller capable of rolling on said surface side to be stuck with label.
